(19) United States
(12) Patent Application Publication
(10) Pub. No.: US 2011/0225084 A1
(43) Pub. Date: Sep. 15, 2011

(54) Method for customer selectable overdraft avoidance

(76) Inventor: Tim Holt, Sarasota, FL (US)

(21) Appl. No.: 12/661,151

(22) Filed: Mar. 11, 2010

(51) Int. Cl. G06Q 40/00; G06Q 20/00; G06Q 10/00

(52) U.S. Cl. 705/38; 705/44

(57) ABSTRACT

A method for providing a bank customer facing an impending overdraft with options for directing the bank as to which transactions to pay and in what order to pay them.

### BACKGROUND

The present invention relates to the field of financial transactions, and in particular, methods for customers to conduct financial transactions in a manner so as to avoid potential bank overdraft charges and/or detrimental credit consequences related to such overdrafts.

The advent of electronic banking and payment processing has created more flexibility in account access and payment options available to banking customers. In accordance therewith, banks have adjusted their service offerings to allow customers the flexibility to use these access and/or payment options in varying manners that heretofore were unavailable.

Given these technology improvements, combined with a desire to allow customers greater financial flexibility, banks have begun providing services enabling the payment of transactions drawn on their customers' accounts even when the customers do not have sufficient funds to cover the transactions. The banks generally provide this service for the payment of a predetermined fee. In processing these transactions, however, it generally has been the banks, not the customers, who have determined which transactions to pay and, more importantly, the order (or presentment) of the transactions. As such, it has been more or less within the control of the banks as to the number and overall total of fees to be assessed for the service.

In view of the foregoing, there is a need for a method for allowing a bank customer the ability to control and/or direct a bank with respect to payment requests drawn on the customer's account, preferably including the ability to control the order of such payments.

### SUMMARY OF THE INVENTION

In a first general aspect of the invention, a method is provided for notifying a bank customer of a potential overdraft situation while providing the customer with access to all pending transactions currently presented against the customer's account.

In a second general aspect of the invention, a method is provided for providing the customer with an update of the customer's current account balance. In a third general aspect of the invention, a method is provided allowing the customer an option for directing the bank as to which of the transactions presented for payment against the customer's account should be paid and which, if any, should be refused. In a fourth general aspect of the invention, a method is provided for allowing the customer an option for selecting the order in which the selected transactions presented for payment against the customer's account should be paid.

### BRIEF DESCRIPTION OF THE DRAWING

FIG. 1 is a schematic view of an embodiment of the method in accordance with the present invention.

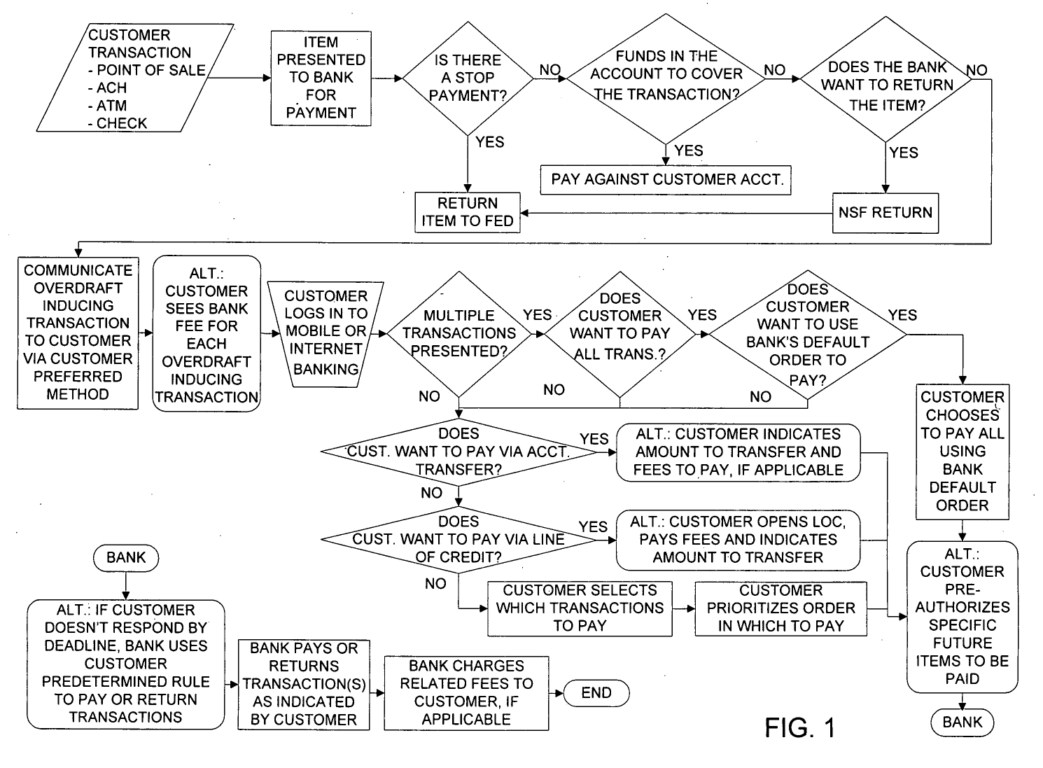

### DETAILED DESCRIPTION OF THE PREFERRED EMBODIMENTS

As is generally known to those of ordinary skill in the art, the general method of check payment is generally the same in most banking institutions and has been for some time. The account holder with the bank (customer) issues a check drawn on his account as a method of cash payment for goods, services, and the like.

Specifically, the process generally proceeds as follows: customer deposits cash with their bank of choice; the bank “credits” or adds the amount to the customer's account balance; customer purchases goods or services; the customer issues a check, or order to pay, to the merchant or provider (payee) payable at the customer's bank; the payee deposits or cashes the check; the bank receiving the deposit or cashing the check (depositor bank) presents the check for payment to the bank (drawer bank) holding the customer account; the drawer bank issues cash or credit to the depositor bank; and the drawer bank withdraws the money from the customer account.

This payment system works sufficiently when the customer has sufficient funds in his account to cover all of the requested payments. However, there are issues when the customer's account does not have sufficient funds. Historically, in such a situation, the next step would be that the drawer bank would refuse payment on the check, returning it, unpaid, to the depositor bank. Such an occurrence generally resulted in significant fees and embarrassment for the customer.

More recently, banks have “relaxed” their position regarding checks or withdrawals presented against insufficient funds and have instituted programs whereby they have agreed to honor or pay the check on behalf of the customer for a pre-set fee. Given the potential advantages for both the customers and the banks, this practice has gained in popularity in recent years and is a service generally offered by most banks. Further, given recent advances in electronic financial transactions, the ability of customers to more easily access and manage their accounts, as well as for banks to more fluidly and efficiently transfer funds, have been greatly improved.

Given the foregoing, the “standard” current payment process generally proceeds as follows: customer deposits cash, a check, has an electronic deposit via ACH, direct payroll deposit, or wire transfer with their bank of choice; the bank “credits” or adds the amount to the customer's account balance; the customer purchases goods or services; the customer issues a check, or uses a debit card, or initiates an electronic or ACH transaction to the merchant or provider (payee) payable at the customer's bank; the payee deposits or cashes the check, the debit card or an ACH transaction is electronically presented; the bank receiving the deposit, electronic funds, or cashing the check (depositor bank) presents the transaction for payment to the bank (drawer bank) holding the customer account; the drawer bank issues cash or credit to the depositor bank; the drawer bank attempts to withdraw the money from the customer account; and, if there are sufficient funds in the customer account, the transaction is withdrawn from the customer balance.

In the case of insufficient funds in the customer account (or where a customer has initiated a stop payment), the drawer bank refuses payment and returns the check unpaid to the depositor bank. Alternatively, depending on the service the customer has signed up for, the bank may pay the transaction pursuant to the customer subscribed service, and charge a fee in accordance therewith. Examples of such services include what may be called Automatic Overdraft Programs (AOPs), Overdraft Protection Programs (ODPs), Courtesy Pay Programs, and the like. Services of this type generally allow the bank to overdraw a customer account up to a set dollar amount. This amount is typically $300-$800, and can be as high as $1,500+ (typically for business customers) or more. In such programs, the customer can generally initiate withdrawals against their account and overdraw their account up to this set dollar amount. Each time a transaction is paid by the bank against the program amount, the bank assesses a fee. Sometimes these fees can be significant, particularly when multiple transactions are involved. All types of transactions initiated by the customer (ACH, ATM, POS, and checks, for example) generally qualify for payment, and therefore the fee. In most of these programs, it is solely within the banks' discretion as to the order in which to pay the checks which can vary by dollar amount, transaction type, check number, and order of receipt. Following payment, in many programs, the customer is notified via email, regular mail, or another method, of the payments and the corresponding assessed fees.

An example of another type of program is a “discretionary” program. This is a program where the bank makes a discretionary decision to pay items for “customers in good standing” against an overdraft. These types of programs generally also assess fees and are generally limited based upon frequency of use and dollar amount involved. In most discretionary programs, notification of the payments and the corresponding assessed fees is through regular mail, although other methods of notification may be used.

The problem with both these types of programs is that it is generally within the banks' discretion as to which payments should be made and in what order. As such, in these programs, it has generally been in the banks', not the customer's, discretion as to the amount of the fees to be assessed. Furthermore, for programs not using an email notification system, there can be a significant time delay before the customer even becomes aware of the overdraft situation, much less the fees that are being charged against the customer's account. Needless to say, given the foregoing, it would be desirable to have a method wherein, in an insufficient funds situation, the customer could be in control of the payments to be made, and thus the fees assessed. More specifically, it would be desirable to have such a system wherein the customer controls not only which transactions should be paid, but also the order of the same.

The present invention provides such a method. Specifically, the present invention provides a method wherein payments of customer initiated bank transactions are directed by the customer. Specifically, in accordance therewith, when an overdraft situation occurs, and as opposed to the prior art method, the bank notifies the customer of the impending overdraft while providing details regarding the payment request(s) (or transaction(s)) responsible for the overdraft. In accordance with the invention, this notification may be provided via email, telephone, text message, instant messaging, mobile phone application, or other means. The customer is then provided with the option of which of the transactions (if any) it wishes for the bank to pay on his account. In one embodiment, the bank may also provide the customer with a recommended priority or order of payment. In this embodiment, the customer can choose to accept the bank's recommended priority, change the order of payment as desired by the customer, or choose to reject payment altogether. In all embodiments, and only following interaction with the customer, the bank then pays the requested transactions against the customer's account and assesses the corresponding fees. In cases where the customer has directed the order of the payments, the bank makes the payments in the directed order. And in cases where the customer rejects payment of some or all of the payments, the respective transaction(s) are returned to the payee.

In an alternate embodiment in accordance with the present invention, the method may include the bank presenting the overdraft inducing transactions for payment with a display of the fee to be charged for each payment (if selected). In another alternate embodiment, the method may include a default situation whereby if a response is not received from the customer in a predetermined amount of time a default rule is acted upon. In such an embodiment, the default rule may direct the bank to pay all transactions, pay none of the transactions, or to pay transactions only up to a certain level of assessed fees

In another alternate embodiment of the present invention, the customer may direct the bank to transfer money from another account (Checking, Savings, LOC, etc.) to pay some or all of the items and pay only a transfer fee. In another embodiment, the customer may direct the bank to transfer money from another account (Checking, Savings, LOC, etc.) to pay some or all of the items and pay fees for only a limited number of items. In yet another embodiment, the customer may direct the bank to pay the currently outstanding items and pre-authorize payment of a certain number or all future items. In doing so, the customer may direct such payment of future items based on payee, check number, and/or amount. Further still, the customer may direct payment of presently due items and pre-authorize the return of some or all future items. Similarly, the customer may direct the bank to pay the presently due items and pre-authorize a single or all transfers from another account for payment of some or all future items. Also similarly, the customer could direct the bank to pay presently due items and pre-authorize a single or all transfers from another account up to a pre-determined dollar amount.

In another alternate embodiment, the customer may concurrently access an additional function and apply for a line of credit (LOC) or loan which may or may not include a fee. In relation thereto, the customer may request an appointment to meet with a bank representative for financial counseling and/or other services provided by the bank, such as balancing their checkbook.

Although the present invention has been described with respect to several preferred embodiments thereof, those skilled in the art will note that various substitutions may be made to those embodiments described herein without departing from the spirit and scope of the present invention.

What is claimed is:

1. A method for conducting a payment transaction in an overdraft situation comprising the steps of:
notifying a customer of the existence of a potential overdraft situation;
providing the customer with a display of at least one transaction presented for payment responsible for the potential overdraft situation;
providing the customer with the option of approving the payment of the at least one transaction or rejecting payment of the at least one transaction; and
paying or not paying the transaction in accordance with the customer direction.

2. The method of claim 1 further comprising the step of providing the customer with a recommended order of order of payment of said at least one transaction.

3. The method of claim 2 wherein the recommended order of payment is chosen so as to minimize customer fees.

4. The method of claim 2 wherein the customer may accept or reject the recommended order of payment.

6. The method of claim 1 wherein the customer notification step is accomplished by email, telephone, text message, instant messaging or mobile phone application.

7. The method of claim 1 further comprising a default rule such that if a customer direction is not received in response to the customer notification within a certain period of time, the default rule is acted upon.

8. The method of claim 7 wherein the default rule acts to pay all of the outstanding transactions, none of the outstanding transactions, or transactions only up to a certain level of assessed fees.

9. The method of claim 1 wherein the step of displaying the at least one transaction presented for payment further comprises displaying the amount of the fee to be charged to the customer if payment for that transaction is selected.

10. The method of claim 1 further comprising the step wherein the customer may direct the bank to transfer money from another account to pay the at least one transaction presented for payment.

11. The method of claim 1 further comprising the step of allowing the customer to select a function for applying for a line of credit.

12. The method of claim 1 further comprising the step of allowing the customer to select a function for requesting an appointment to meet with a bank representative.

13. A method for conducting a payment transaction in an overdraft situation comprising the steps of:
notifying a customer of the existence of a potential overdraft situation;
providing the customer with a display of at least one transaction presented for payment responsible for the potential overdraft situation;
providing the customer with a preferred order of payment of said at least one transaction chosen to minimize fees for the customer;
providing the customer with the option of approving the payment of the at least one transaction, rejecting payment of the at least one transaction, or transferring funds from another account for the payment of the at least one transaction; and
paying or not paying the at least one transaction in accordance with the customer direction.

14. The method of claim 13 wherein the customer may accept or reject the recommended order of payment.

15. The method of claim 13 wherein the customer notification step is accomplished by email, telephone, text message, instant messaging or mobile phone application.

16. The method of claim 13 further comprising a default rule such that if a customer direction is not received in response to the customer notification within a certain period of time, the default rule is acted upon.

17. The method of claim 16 wherein the default rule acts to pay all of the outstanding transactions, none of the outstanding transactions, or transactions only up to a certain level of assessed fees.

18. The method of claim 13 wherein the step of displaying the at least one transaction presented for payment further comprises displaying the amount of the fee to be charged to the customer if payment for that transaction is selected.

19. The method of claim 13 further comprising the step wherein the customer may direct the bank to transfer money from another account to pay the at least one transaction presented for payment.

20. A method for conducting a payment transaction in an overdraft situation comprising the steps of:
notifying a customer via email, telephone, text message, instant messaging or mobile phone application of the existence of a potential overdraft situation;
providing the customer with a display of at least one transaction presented for payment responsible for the potential overdraft situation;
providing the customer with a preferred order of payment of said at least one transaction chosen to minimize fees for the customer;
displaying a fee associated with payment of each of said transactions;
providing the customer with the option of approving the payment of the at least one transaction, rejecting payment of the at least one transaction, or transferring funds from another account for the payment of the at least one transaction; and
paying or not paying the at least one transaction in accordance with the customer direction or, if the notification is not acted upon in a certain period of time, acting on the at least on transaction in accordance with a default rule.
